(19) United States
(12) Patent Application Publication
(10) Pub. No.: US 2019/0072054 A1
(43) Pub. Date: Mar. 7, 2019

(54) ROCKET ENGINE WITH GROUND-BASED IGNITION

(71) Applicant: ARIANEGROUP SAS, Paris (FR)

(72) Inventors: Alain PYRE, SAINT-JUST (FR); Cindy MERLIN, SAINT AUBIN SUR GAILLON (FR)

(73) Assignee: ARIANEGROUP SAS, Paris (FR)

(21) Appl. No.: 16/082,638

(22) PCT Filed: Mar. 7, 2017
(86) PCT No.: PCT/FR2017/050506

§ 371 Date: Sep. 6, 2018

(30) Foreign Application Priority Data
Mar. 7, 2016 (FR) 1600377

(51) Int. Cl. F02K 9/95; F02K 9/97; F02K 9/62

(52) U.S. Cl. CPC F02K 9/95; F02K 9/978; F05D 2260/99; F05D 2240/35; F05D 2240/128; F02K 9/62

(57) ABSTRACT

The present disclosure relates to a rocket engine obtaining safer and better controlled ground-based ignition, the rocket engine comprising an axisymmetric propulsion chamber (12), including a throat (12c) at which the diameter of the propulsion chamber (12) is a minimum, an injection head (11) configured to inject at least one liquid propellant into the propulsion chamber (12), and a destructible tubular guide (40), applied coaxially in the propulsion chamber (12) so as to channel said propellant downstream of the throat (12c) of the propulsion chamber (12).

### FIELD OF THE INVENTION

The present disclosure relates to a rocket engine obtaining safer and better controlled ground-based ignition.

Such a rocket engine can in particular equip the first stage or the single stage of a commercial launcher, of a missile or of any other type of rocket or vehicle with civil or military uses.

### PRIOR ART

The main engines, using liquid propellants, of the first stages of launchers being ignited when the launcher is still on the ground, it is possible to ignite them using torches provided on the firing point, which makes it possible to dispense with an internal ignition device and therefore offers a substantial saving in on-board mass and in cost.

Thus, as shown in FIG. 2, during conventional ground-based ignition, the injection head 92 of the rocket engine 91 injects liquid propellants into the propulsion chamber 93: the propellants then flow into the propulsion chamber (93), then fall toward the ground in the manner of a substantially conical shower from the throat 93c of the propulsion chamber 93. Igniting torches 94, mounted on the firing point, then project a flame in the direction of the axis of symmetry A of the rocket engine 91, in a zone relatively close to the downstream end of the divergent nozzle 95 of the rocket engine 91, so as to fire the propellants and therefore achieve the ignition of the engine 91.

However, the detonation which occurs at the time of ignition causes considerable axial and lateral loads which can damage, in particular, the propulsion chamber 93, the divergent nozzle 95, the hinge 97, or the rams 98 of the engine 91, or the launcher situated above the hinge 97. These members must therefore be dimensioned accordingly.

In addition, due to the conical flow of the propellants downstream of the throat 93c, the effective ignition zone 96 can be substantially offset with respect to the axis of symmetry A of the engine 91.

Such an offset therefore causes asymmetric lateral loads 99 during detonation and therefore causes considerably bending moments applied to the rocket engine. Naturally, the more eccentric the ignition zone, the greater these lateral loads and these bending moments.

At present, one option for combating these effects is to use long and intrusive ignition torches allowing the propellants to be ignited farther upstream in the rocket engine and in a zone closer to the axis of symmetry of the engine.

These intrusive torches, however, which are consequently subjected to the high temperatures and pressures of the operating engine, are costly and require considerable maintenance between launches.

There exists therefore a real need for a rocket engine obtaining safer and better controlled ground-based ignition and which are lacking, at least partly, the disadvantages inherent in the aforementioned known methods.

### PRESENTATION OF THE INVENTION

The present disclosure relates to a rocket engine comprising an axisymmetric propulsion chamber, including a throat at which the diameter of the propulsion chamber is a minimum, an injection head configured to inject at least one liquid propellant into the propulsion chamber, and a destructible tubular guide applied coaxially in the propulsion chamber so as to channel said propellant downstream of the throat of the propulsion chamber.

In the present disclosure, what is meant by “destructible” is an element which can be destroyed or at least ejected by the rocket engine during normal operation of the latter, when its ignition has been accomplished and its steady-state operating point has been reached. Moreover, in the present disclosure, the terms “axial,” “radial,” “tangential,” “interior,” “exterior” and their derivatives are defined with respect the main axis of the rocket engine; an “axial plane” is considered to be a plane passing through the main axis of the rocket engine and a “radial plane” is a plane perpendicular to this main axis; finally, the terms “upstream” and “downstream” are defined with respect to the circulation of fluids in the rocket engine.

Thanks to such a guide, the cost of which is very low, the propellants are channeled in the interior volume of the guide around the axis of symmetry of the propulsion chamber and are no longer dispersed in the propulsion chamber upon leaving the throat. It is then possible to point the ignition torches of the firing point toward the lower portion of the guide so as to accomplish ignition further up in the rocket engine and closer to its axis of symmetry. As a result, the lateral loads caused by the detonation are weaker and less asymmetrical: the forces to which the components of the rocket engine are subjected are therefore weaker. These components can then be made lighter, thus reducing the total mass of the rocket engine.

In addition, the guide contains the ignition zone and can contribute to absorbing a portion of the detonation energy during ignition, which contributes toward reducing the loads to which the propulsion chamber is subjected.

Moreover, the guide is configured to be destroyed and ejected by the detonation or, at the latest, by the heat and the flow speed of combustion gases when the engine begins to operate: hence it does not affect the performance of the rocket engine and does not make it heavier.

In certain embodiments, the diameter of the propulsion chamber is reduced starting at its upstream end, which is connected to the injection head, toward its throat, then increases again from its throat to its downstream end.

In certain embodiments, the guide is axisymmetrical. This promotes ignition in proximity to the axis of symmetry of the rocket engine.

In certain embodiments, the guide is cylindrical, preferably with a circular base. This promotes flow parallel to the axis of symmetry by reducing the lateral dispersion of the propellant, which promotes ignition in proximity to the axis of symmetry of the rocket engine.

In other embodiments, the guide is conical, preferably converging downstream.

In certain embodiments, the guide extends from the throat of the propulsion chamber. The propellant thus flows continuously from the upstream portion of the propulsion chamber toward the guide.

In certain embodiments, the guide is attached in a sealed fashion to the throat of the propulsion chamber. It can in particular be attached by means of adhesive tape or by any other destructible attachment means.

In certain embodiments, the guide extends at least until the downstream end of the propulsion chamber.

In certain embodiments, the rocket engine also comprises a divergent nozzle connected to the downstream end of the propulsion chamber.

In certain embodiments, the guide extends into the divergent nozzle over at most 20% of the length of the divergent nozzle, preferably over at most 10% of the length of the divergent nozzle, or over 0% of the length of the divergent nozzle. In this manner, it is possible to achieve ignition rather high in the rocket engine so as to reduce the risk of asymmetric ignition.

In certain embodiments, the guide is lightweight. The guide thus preferably weighs less than 5 kg.

In certain embodiments, the guide is flexible. It can thus, for example, be made of cloth or of plastic.

In certain embodiments, the guide has a thickness of less than 10 mm, preferably comprised between 2 and 10 mm.

In certain embodiments, at least one portion of the guide, preferably its upstream portion, possibly the entire guide, is configured to tear when a pressure greater than 5 bar is exerted on its interior face. In this manner, the guide tears at the moment of detonation, which contributes to its destruction and to its removal.

In certain embodiments, at least this portion of the guide, possibly the entire guide, is made of plastic. However, other materials are naturally possible.

In certain embodiments, at least one portion of the guide, preferably its downstream portion, is configured to resist a least 2 seconds to a temperature of 1700° C. In this manner, the guide resists and remains in place long enough for the ignition of the engine by means of the ignition torches, such ignition generally requiring one to two seconds

In certain embodiments, at least this portion of the guide, possibly the entire guide, is made of a thermally insulating material. It can thus comprise a cloth made of silica fibers, cork, a Nextel (registered trademark) coating, or an MLI Jehier (registered trademark) multilayer material, to cite only these examples.

In certain embodiments, at least this portion of the guide, possibly the entire guide, is provided with an interior thermally protective coating.

In certain embodiments, the propulsion chamber is devoid of an internal ignition device.

The present disclosure also relates to an assembly comprising a rocket engine according to any one of the preceding embodiments and a launch pad, the rocket engine being positioned on the launch pad.

In certain embodiments, the launch pad comprises at least one ignition torch configured to project a flame toward the interior space of the guide of the rocket engine.

In certain embodiments, said ignition torch, preferably each ignition torch, points toward a zone situated along the axis of the rocket engine and not situated lower than 20% of the length of the divergent nozzle of the rocket engine, starting from the upstream end of the divergent nozzle. Preferably, the ignition torch points toward a zone situated upstream of the interface between the propulsion chamber and the divergent nozzle. This allows a reduction in the risk of asymmetrical ignition.

In certain embodiments, said ignition torch, preferably each ignition torch, does not penetrate into the interior of the rocket engine. In this manner, the cost and the maintenance of the ignition torch is reduced.

The aforementioned features and advantages, as well as others, will appear upon reading the detailed description that follows, of exemplary embodiments of the proposed rocket engine. This detailed description makes reference to the appended drawings.

### BRIEF DESCRIPTION OF THE DRAWINGS

The appended drawings are schematic and aim primarily to illustrate the principles of the invention.

FIG. 1 is a section plan of a rocket engine according to the invention.

FIG. 2 is a section plan of a rocket engine according to the prior art.

### DETAILED DESCRIPTION OF EXEMPLARY EMBODIMENT(S)

In order to make the invention more concrete, an example of a rocket engine is described in detail hereafter, with reference to the appended drawings. It is recalled that the invention is not limited to this example.

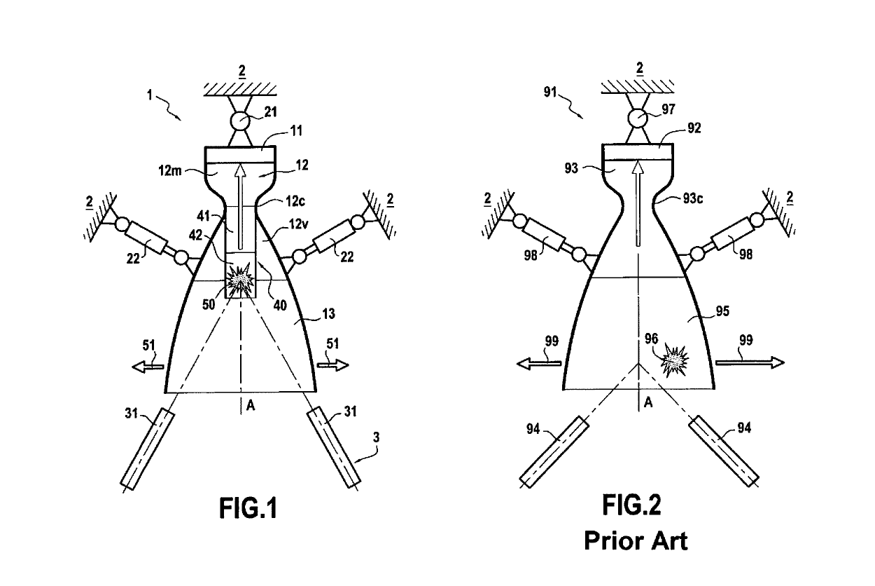

FIG. 1 shows, in section along a vertical plane passing through its main axis A, a rocket motor 1 according to the invention. It includes, from upstream to downstream, an injection head 11, a propulsion chamber 12 and a divergent nozzle. This assembly is mounted on a launcher 2 by means of a gimbal hinge 21, mounted at its upper end, and lateral rams 22.

The propulsion chamber 12, symmetrical about the axis A of the engine 1, is connected by its upstream end to the injection head 11. The diameter of the propulsion chamber then decreases downstream until it reaches a minimum, forming a throat 12c, before increasing again until the downstream end of the propulsion chamber. This downstream end is connected to the divergent nozzle 13 of the engine 1.

During the normal operation of the engine 1, in steady-state operation, the injection head 1 injects a mixture of two liquid propellants into the upstream portion 12m of the propulsion chamber 12; the combustion of the propellants then occurs in this portion 12m of the propulsion chamber 12, forming a combustion chamber, and generates a considerable quantity of combustion gases ejected downstream at high speed; passing the throat 12c of the propulsion chamber allows the combustion gases to be accelerated while its downstream portion 12v and the divergent nozzle 13 ensure the expansion of the combustion gases prior to the ejection at the downstream end of the divergent nozzle 13, thus ensuring opposite thrust directed upward and allowing the launcher to be propelled.

During preparation for launch, the launcher 2 is placed on the launching pad 3 of a firing point, this launching pad 3 being equipped with ignition torches 31 which do not penetrate inside the rocket engine 1.

In addition, a tubular guide 40, cylindrical with a circular base in this case, the diameter of which is substantially equal to that of the throat 12c of the propulsion chamber 12, is mounted in the rocket engine 1 coaxially with the main axis A. This tubular guide 40 has two portions connected to one another by sealed means: an upstream portion 41, made of plastic, and a downstream portion 42, made of a thermally insulating material comprising silica fibers.

The upstream end of the tubular guide 40 is attached to the throat 12c of the propulsion chamber 12, for example by means of adhesive tape. It thus extends into the downstream portion 12v of the propulsion chamber 12 from the throat 12c and penetrated in part into the divergent nozzle 13. In this example, the downstream end of the tubular guide 40 is situated at approximately 15% of the length of the divergent nozzle 13, starting from the upstream end of the divergent nozzle 13.

The ignition torches 31 are then oriented so as to point toward the downstream portion 42 of the tubular guide 40.

To ignite the engine 1, the two liquid propellants are injected by means of the injection head 11; the latters then flow into the upstream portion 12m of the propulsion chamber 12, then into the tubular guide 40 without being dispersed laterally. The ignition torches 31 are then lit and each projects a flame in the direction of the interior volume of the downstream portion 42 of the tubular guide 40, i.e. in the direction of the main axis A of the engine 1 and at the interface 15 between the propulsion chamber 12 and the divergent nozzle 13. This step can last for one to two seconds before the propellants fire: the thermally insulating material of the downstream portion 42 of the tubular guide 40 then allows the latter to resist until the effective ignition of the engine.

Thus, thanks to the tubular guide 40, the ignition of the propellants occurs in a controlled ignition zone 50 situated in the interior of the tubular guide 40, rather precisely on the axis of symmetry A of the rocket engine 1, which causes symmetrical, and therefore relatively weak, lateral loads 51.

During detonation, the tubular guide 40 tears and is ejected out of the rocket engine 1 by the detonation blast. Once ignition occurs, the heat and the speed of the combustion gases allow the destruction and/or ejection of possible residues of the tubular guide 40 and of its means of attachment.

The embodiments or exemplary embodiments described in the present disclosure are given by way of illustration and are not limiting, a person skilled in the art being able to easily, upon seeing this disclosure, modify these embodiments or exemplary embodiments, or conceive others, while remaining within the scope of the invention.

Moreover, the different features of these embodiments or exemplary embodiments can be used alone or be combined together. When they are combined, these features can be combined as well as described above or differently, the invention not being limited to the specific combinations described in the present disclosure. In particular, unless otherwise specified, a features described in relation with an embodiment or exemplary embodiment can be applied analogously to another embodiment or exemplary embodiment.

1. A rocket engine, comprising
an axisymmetric propulsion chamber, including a throat at which the diameter of the propulsion chamber is a minimum,
an injection head configured to inject at least one liquid propellant into the propulsion chamber, and
a destructible tubular guide, applied coaxially in the propulsion chamber so as to channel said propellant downstream of the throat of the propulsion chamber, at least one portion of the guide being configured to resist at least 2 seconds at a temperature of 1700° C.

2. The rocket engine according to claim 1, wherein the guide is axisymmetric.

3. The rocket engine according to claim 1, wherein the guide is attached in a sealed fashion to the throat of the propulsion chamber.

4. The rocket engine according to claim 1, comprising a divergent nozzle connected to the downstream end of the propulsion chamber,
wherein the guide extends into the divergent nozzle over at most 20% of the length of the divergent nozzle.

5. The rocket engine according to claim 1, wherein the guide is configured to tear when a pressure greater than 5 bar is exerted on its interior face.

6. The rocket motor according to claim 1, wherein the guide extends from the throat of the propulsion chamber.

7. The rocket motor according to claim 1, wherein the propulsion chamber is devoid of an internal ignition device.

8. An assembly comprising a rocket engine according to claim 1 and a launch pad, the rocket engine being positioned on the launch pad,
wherein the launch pad comprises at least one ignition torch configured to project a flame toward the interior space of the guide of the rocket engine.

9. The assembly according to claim 8, wherein the rocket engine comprises a divergent nozzle connected to the downstream end of the propulsion chamber, and
wherein said ignition torch points toward a zone situated along the axis of the rocket engine and not situated lower than 20% of the length of the divergent nozzle of the rocket engine starting from the upstream end of the divergent nozzle.

10. The assembly according to claim 8, wherein said ignition torch does not penetrate into the interior of the rocket engine.
